(19) United States
(12) Patent Application Publication
(10) Pub. No.: US 2018/0345764 A1
(43) Pub. Date: Dec. 6, 2018

(54) VEHICLE SCREEN MOLDING

(71) Applicants: Leslie Derheim, Dickinson, ND (US); Toni Malsey, Dickinson, ND (US)

(72) Inventors: Leslie Derheim, Dickinson, ND (US); Toni Malsey, Dickinson, ND (US)

(21) Appl. No.: 15/607,740

(22) Filed: May 30, 2017

(51) Int. Cl. B60J 1/20

(52) U.S. Cl. CPC B60J 1/2063; B60J 1/008; B60J 1/20

(57) ABSTRACT

A vehicle screen molding that includes: a fin, where the fin is adapted to insert into a window opening; a skirt attached to on top of the fin; and a crown on top of the skirt, where the crown is adapted to receive a screen. The crown preferably includes a slot, where the crown is oval shaped. The crown may include a first half on a first side of the crown and a second half on a second side of the crown.

### BACKGROUND OF THE INVENTION

### Field of Invention

The present invention relates to a screen molding that is inserted into a window for screen placement.

### Description of Related Art

Motor vehicles have open windows that are available to allow transfer of air into the interior of the vehicle. Most modern vehicles allow for the lowering and raising of the windows automatically through push button controls. The open window allows the driver and passengers to enjoy fresh air while riding in the vehicle. However, the vehicle is moving and on occasion insects may transfer into the interior of the vehicle with the open windows. Further, an individual may desire to leave the windows open while parked so consequently the open window provides access by outside insects. One common method to prevent the transfer of insects to the interior of a building or otherwise is the use of a screen. The screen may be mounted in the window opening to prevent the influx of insects and allow a flow of air into the interior. As a result, it could be advantageous to implement the use of a screen in the motor vehicle. However, motor vehicles are usually not equipped with any type of screen to block the flow of insects into the interior of the vehicle. It would therefore be advantageous to have an add-on material that could be inserted in the window to support and mount the screen at least on a temporary basis to prevent the flow of bugs therein.

### SUMMARY OF THE INVENTION

The present invention relates to a vehicle screen molding that includes: a fin, where the fin is adapted to insert into a window opening; a skirt attached to on top of the fin; and a crown on top of the skirt, where the crown is adapted to receive a screen. The crown preferably includes a slot, where the crown is oval shaped. The crown may include a first half on a first side of the crown and a second half on a second side of the crown.

### BRIEF DESCRIPTION OF DRAWINGS

FIG. 1 shows the screen and screen molding in accordance with the present invention.

FIG. 2 depicts components of the screen molding and a sectional view.

FIG. 3 depicts a prospective view of the screen molding in accordance with the present invention.

### DETAILED DESCRIPTION

The present invention relates to molding that includes an ability to receive a screen and mount the screen within an opening of the vehicle window. The molding includes a fin that inserts into the groove opening that provides for the transfer of the car window and once placed within the opening the mold may receive a screen within a slit or slot provided within the molding. The molding is essentially crown-shaped placed on a skirt sleeve. Below the sleeve is a fin that secures the molding into the window opening.

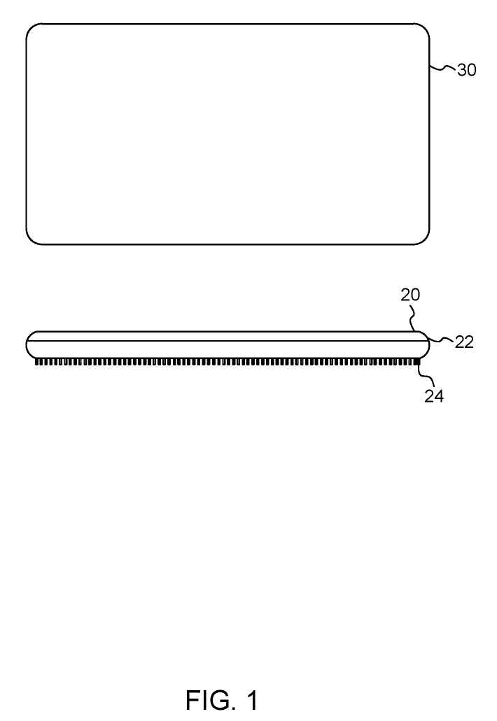

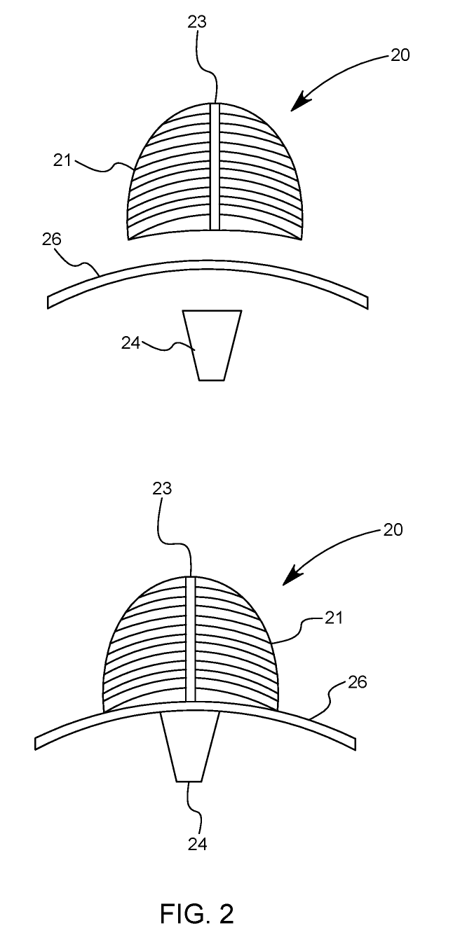

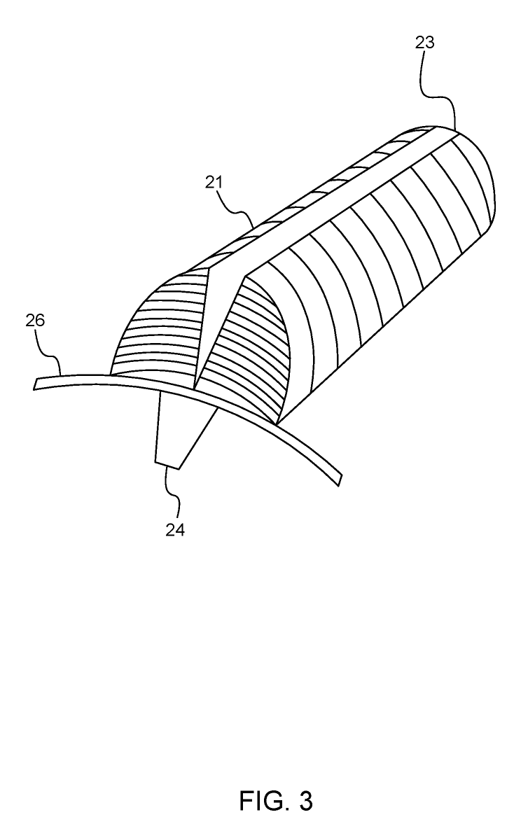

In reference to FIG. 1, a screen 30 is shown above a screen molding 20. The screen molding 20 is depicted in a side view that includes slot opening 22 that receives the screen 30. Fin 24 provided along the bottom of the molding 20 that insert into the slot for the window in order to secure the molding in place. A sectional view is provided in FIG. 2 of molding 20. In the sectional view, each component is shown where fin 24 supports the screen molding 20, which includes a skirt 26 and crown 21. This crown 21 is oval-shaped with a slot 23 down the center thereof. The slot 23 receives the screen 30 for mounting within the molding 20. A perspective view is provided in FIG. 3 showing the crown 21 and the extended mount of the slot 23. Once placed into a vehicle window ultimately the molding is available to receive a screen as desired by the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A vehicle screen molding comprising:
a. a fin, where the fin is adapted to insert into a window opening;
b. a skirt attached to on top of the fin; and
c. a crown on top of the skirt, where the crown is adapted to receive a screen.

2. The vehicle screen molding according to claim 1, where the crown includes a slot.

3. The vehicle screen molding according to claim 2, where the crown is oval shaped.

4. The vehicle screen molding according to claim 3, where the crown includes a first half on a first side of the crown and a second half on a second side of the crown.
